(19) United States
(12) Patent Application Publication
(10) Pub. No.: US 2003/0140252 A1
(43) Pub. Date: Jul. 24, 2003

(54) Authentication process and device

(76) Inventors: Martin Lafon, Orsay (FR); Gilles Kremer, Vanvos (FR)

Correspondence Address: YOUNG & THOMPSON, 745 SOUTH 23RD STREET 2ND FLOOR, ARLINGTON, VA, 22202

(21) Appl. No.: 10/198,998

(22) Filed: Jul. 22, 2002

(30) Foreign Application Priority Data
Jul. 20, 2001 (FR) 01 10042
Dec. 13, 2001 (FR) 01 16173

(51) Int. Cl. H04L 9/00

(52) U.S. Cl. 713/201

(57) ABSTRACT

The process of certification comprises:

an operation of identifying a user (155) in the course of which said user transmits to a server, by means of a first terminal (100) on a first communication network (110), a certificate representing, in a coded manner, a unique address of a second terminal (140) of said user on a second communication network (130),

an operation of decoding (157) said unique address by said server, and

an operation of communication (161) between said server and the second terminal.

The present invention relates to a certification process and device. In particular, the present invention relates to the transmission of data on line, for example on the Internet.

Because of its open nature, the Internet has increased the need for security of data transmission. Thus, the architecture itself of the Internet renders it particularly vulnerable: the IP protocol, totally decentralized, causes to circulate datagrams or “packets” without their being protected. The IP addresses themselves, controlled by the DNS (Domain Name Services), are not protected from malfeasance. The systems of exploitation have security lapses. Here is an impressive list of dangers:

listening to packets or “sniffing”;

substitution of packets or “spoofing”;

DNS pirating;

denial of service;

intrusions; and

dissemination of harmful, virus or Trojan horse programs.

Cryptology is not the answer to all these questions. In cryptology, a key is inserted at the time of encoding the data so as to ensure their confidentiality. The different available security standards, for electronic transmission, for communication sessions on the web (SSL or “Secure Socket Layer”) , for the IP protocol itself (IPsec), use the whole arsenal of modern methods: authentication and signature, conventional key exchange, symmetric encoding. Hundreds of millions of RSA keys have thus been produced.

However, new problems arise: how to control these keys? As noted by Jacques Stern, Director of the Computer Department of the Ecole Normale Supérieure “there is no sense in using RSA encoding while scattering secret keys on a hard disc improperly protected against intrusion” (in an article published in Le Monde dated Sep. 12, 2000). Moreover, the question arises of connecting a public RSA key to its legitimate owner.

The present invention seeks to overcome all or a portion of these drawbacks. To this end, the present invention provides, according to a first aspect, a certification process, characterized in that it comprises:

an operation of identifying a user in the course of which said user transmits to a server, by means of a first terminal over a first communication network, a certificate representing, in an encoded manner, a unique address of a second terminal of said user over a second communication network,

an operation of decoding said unique address by said server, and

an operation of communication between said server and a second terminal.

Thanks to these arrangements, said server does not need to recognize the unique address of the second terminal but only the decoding key to obtain this unique address. The unique address is thus protected because it is not saved on a database accessible by the server. The encoding of said unique address protects it also against undesired disclosure by the user.

According to particular characteristics, the process of the invention as briefly set forth above, comprises moreover:

an operation of transmitting unpredictable information, by said server, to the second terminal,

an operation of transmission to said server by means of the first terminal of said unpredictable information,

an operation of verifying said unpredictable information by said server and

if the verification is positive, an operation of authorizing access of the first terminal to a first communication network resource.

Thanks to these arrangements, said user is authenticated by said server.

According to particular characteristics of the process of the invention as briefly set forth above, in the course of the identification operation, said user transmits to the server, by means of a first communication network, a certificate representing (encoded with a public key) the unique address of the second terminal.

Thanks to these arrangements, only the server can decode said unique address but it is not necessary that he preserve it in a database to obtain it. The unique address is thus doubly protected.

According to a second aspect, the present invention provides a process for certification characterized in that it uses a user's database comprising, for each user, a means for obtaining a unique address of a terminal on a communication network (for example said unique address or a decoding key) and a pointer identifying another database comprising the electronic signature information.

According to a third aspect, the present invention provides a process for certification characterized in that it uses a certificate according to an infrastructure with asymmetric keys, such as the public key infrastructure PKI, identifying a user, comprising:

a field representative of a unique address of a user terminal of said user, and

a certificate according to said infrastructure with asymmetric keys not representing said unique address.

Thanks to these arrangements, the user can be identified by the use of said terminal whilst using any certificate used by another certification authority.

The present invention also provides a process and device for authorization of access to a resource accessible online. It provides in particular with referencing, in a database, users of an authentication service and, still more particularly permits users to provide the information or to select a destination, for identifying each portion of the transfer of information.

To fill a database, it is known to collect information, then to fill the fields of said database. In the field of authentication, to authenticate a user, source or information destination, it is at present known to call up said user requiring him to produce identification and, if desired, a proof of residence, then to give him a route of electronic certificate which permits him, once he has used his computer, to obtain an electronic certificate which remains attached to his computer.

This procedure is very difficult for the user. Moreover, if the addressee of information does not possess a certificate, the user sending him information cannot at present reference it into the database.

The present invention seeks to overcome these drawbacks.

To this end, the present invention provides, according to a fourth aspect, a process for authorizing access of a user to a resource accessible by means of a computer network, characterized in that it comprises:

a step of providing, on the computer network, by said user, an electronic address that he has,

a step of transmission, by a server, to said electronic address of said user, of an electronic message inviting said user to reply thereto,

a step of providing, by said user, a “unique” address of said user on a communication network with different unique addresses of said computer network,

when the user responds to said electronic message, a step of transmission, by said server, to said unique address, of unpredictable information,

a step of transmission, by said user, to said server, of said unpredictable information,

a first step of verifying the correspondence of said unpredictable information transmitted by said server and of said unpredictable information transmitted by said user,

if the verification of correspondence of the unpredictable information is positive, a step of memorizing, associated with the unique address of the user, the electronic address of the user.

Thanks to these arrangements, the referencing of the user can be carried out by himself without needing to go to a registration site.

According to particular characteristics, the process as briefly set forth above moreover comprises:

a step of transmission, by said user, to said server, of confidential information and identification information,

a second step of verification, by a server, of the correspondence of said confidential information and of said identification information,

if, on the one hand, the verification of correspondence of the unpredictable information is positive, and, on the other hand, the verification of correspondence of the confidential information is positive, a step of memorizing, associated with the unique address of the user, of the electronic address of the user, of the confidential information and of the identification information.

According to particular characteristics, said confidential information identifies a payment means, for example the coordinates of a bank account, if desired with single use or an electronic money carrier.

Thanks to each of these arrangements, the user can use confidential services, for example to access financial, social or fiscal data or to carry out payments.

According to particular characteristics, the process as briefly described above comprises a repetition of the second verification step, which concerns confidential information. Thus, if the user is no longer a subscriber to a service, the second step of verification gives a negative result and measures can be taken to prevent the user from using said services. According to particular characteristics, the repetition of the second verification step takes place:

at each attempt for access to said service;

at each payment;

each time a payment mode is selected.

Thanks to these arrangements, the validity of the access or the payment is verified at each attempt at access or of payment.

According to particular characteristics, in the course of the step of providing a unique address, said communication network is a telephone network. Thus, the process is easy to use and does not require the user to have specific means for authentication.

According to particular characteristics, the electronic message comprises a connection to an address on the computer network and the user responds to the electronic message by clicking on said connection. The use of the process is thus facilitated because the user responds, by simple selection of the connection to the electronic message.

According to particular characteristics, the process as briefly set forth above comprises an operation of providing data by the user and said unpredictable information is representative of said data. Thanks to these arrangements, the unpredictable information is definitively associated with the transmitted data and thus corresponds to the rules in force in the field of electronic signature.

According to particular characteristics, the process as briefly set forth above comprises a step of determining an identification of a password of the user and, in the course of the memorization step, said identification or password is associated with the electronic address and the unique address of the user. Thus, supplemental safety is added because, even if a third person simultaneously had the electronic address and the unique address, he could not carry out the authentication without the identification or the password of the user.

According to particular characteristics, the process as briefly set forth above comprises a step of electronic signature, by said server, of data transmitted by the user. Thanks to these arrangements, the user can use different terminals to sign the transmitted data, even if these terminals do not have the electronic address of the user, the latter being used by the server.

According to particular characteristics, the process as briefly set forth above comprises a step of transmission, by the user, of a hash of data of the user. Thanks to these arrangements, the integrity of the data of the user can be guaranteed by the verification of the hash, by the server and/or by the user.

According to particular characteristics, the process as briefly set forth above comprises a step of using an electronic certificate of the user and the step of memorization comprises an association step, in the database, of an identification of said electronic certificate or of an organism having emitted said electronic certificate to the electronic address of the user and to the unique address of the user. Thanks to these arrangements, the reduced authentication which the electronic certificate offers is greatly reinforced by the authentication and the trackability which ensures the transmission of unpredictable information to the unique address of the user.

According to a fifth aspect, the present invention provides a device for authorization of access of a user to an accessible resource by means of a computer network, characterized in that it comprises a terminal adapted to the provision, on the computer network, by the user, of an electronic address that he has, by transmission means, by a server, to said electronic address of said user, of an electronic message inviting said user to respond thereto, said terminal being, moreover, adapted to supply, by said user, a “unique address” address of said user on a communication network with unique addresses different from said computer network, the server being adapted, when the user responds to said electronic message, to transmit to said unique address unpredictable information, said terminal being adapted to transmit to said server, said unpredictable information, said server being adapted to verify the correspondence of said unpredictable information transmitted by said server and said unpredictable information transmitted by said user, and if the verification of correspondence of the unpredictable information is positive, to memorize the electronic address of the user associated with the unique address of the user.

The objects, advantages and particular characteristics of this fifth aspect being identical to those of the fourth aspect, they will not be repeated here.

Other advantages, objects and characteristics of the present invention will become apparent from the description which follows, given by way of explanation and in no way limiting, with reference to the accompanying drawings, in which:

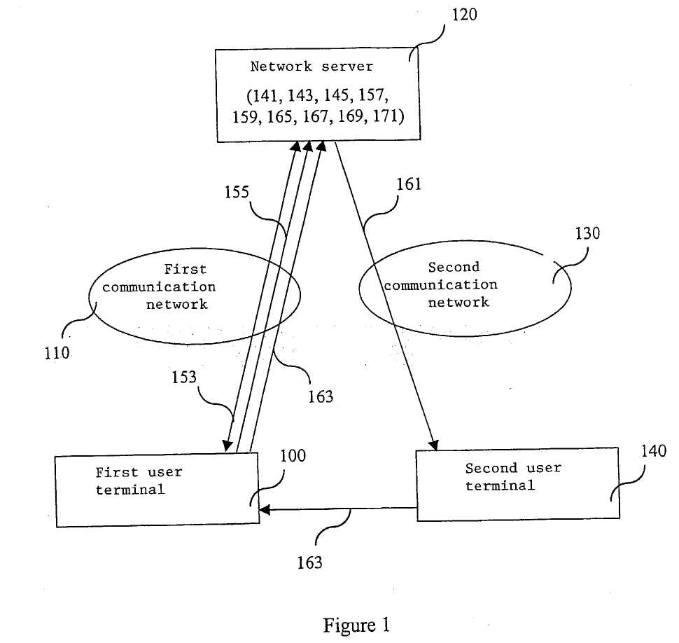

FIG. 1 is a succession of message transmissions according to an exemplary practice of the present invention,

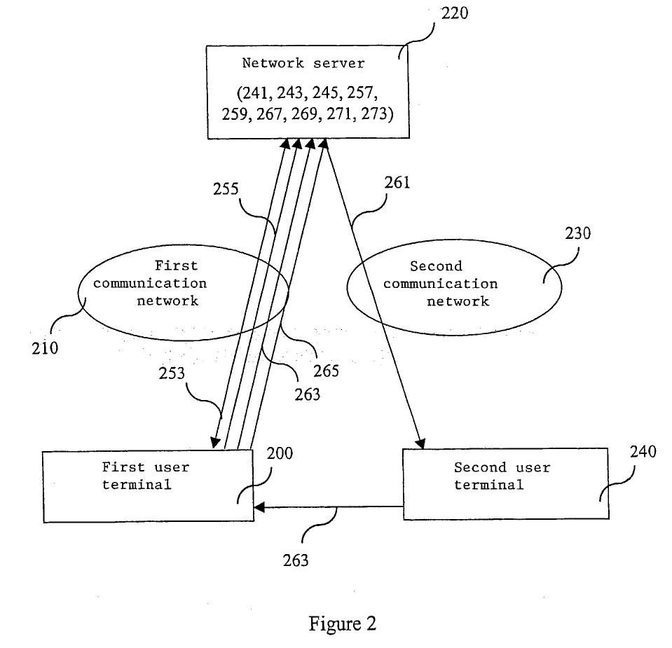

FIG. 2 is a series of operations used according to an exemplary aspect of the present invention,

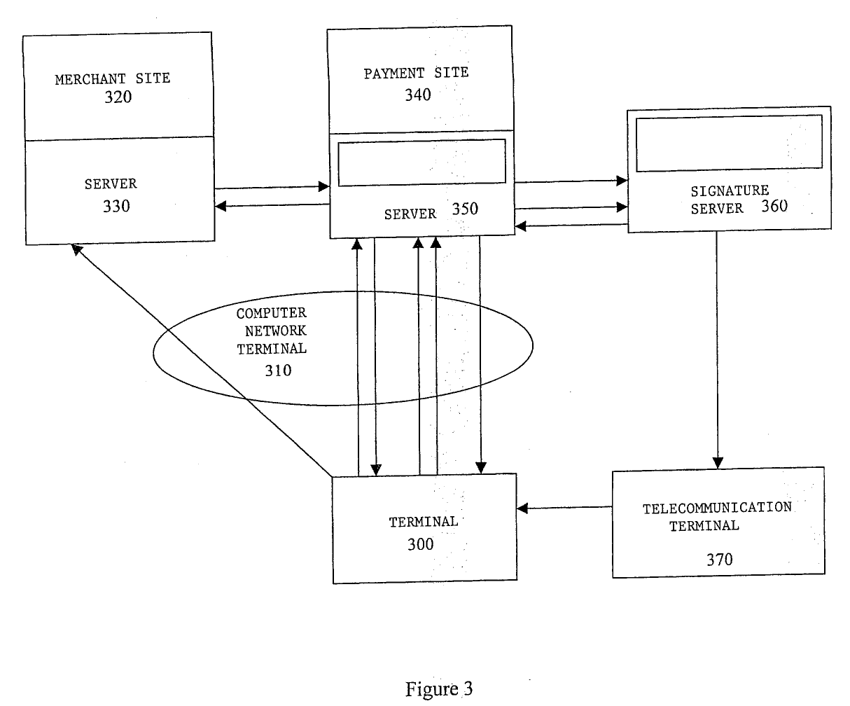

FIG. 3 shows transmissions of messages between entities participating in a transaction, according to a second embodiment,

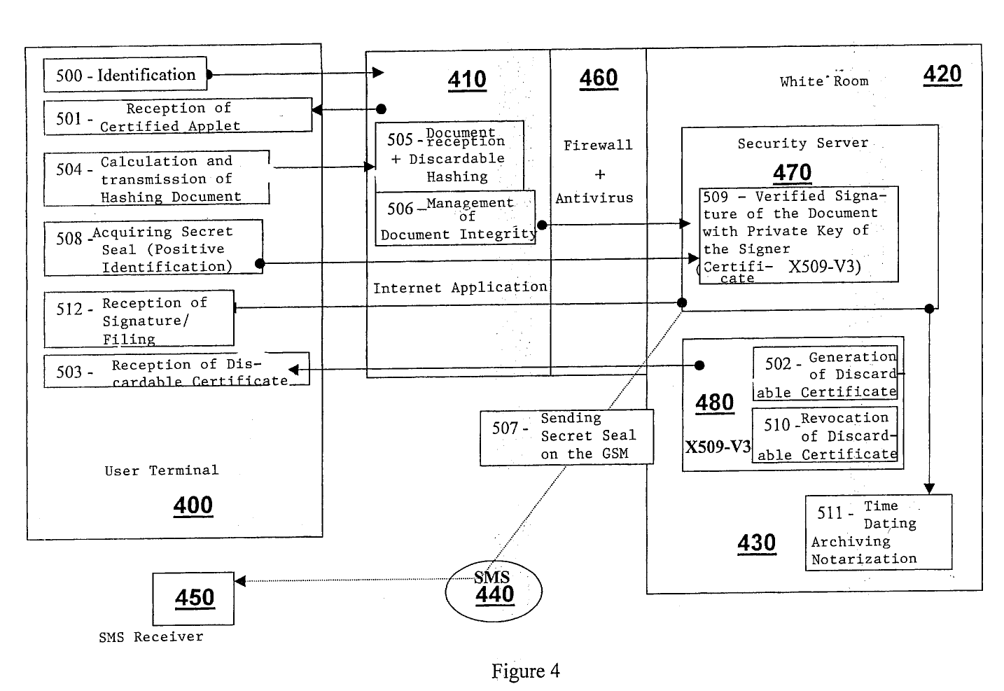

FIG. 4 shows a series of operations carried out by a user terminal and a certification server, in a particular embodiment of the present invention,

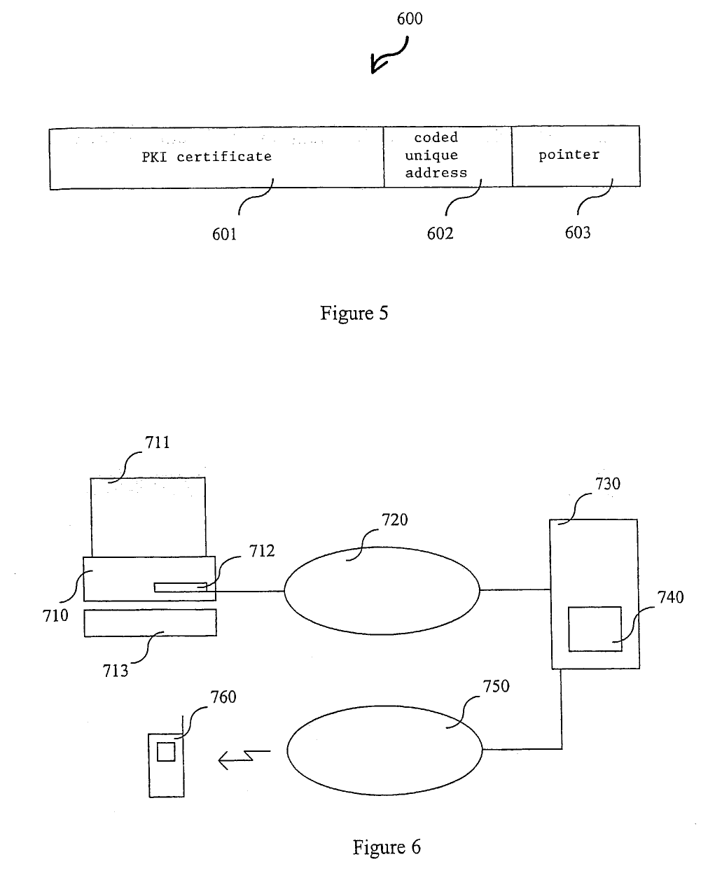

FIG. 5 shows the fields of a certificate according to the public key infrastructure PKI, according to one aspect of the present invention and fields of a database according to another aspect of the present invention,

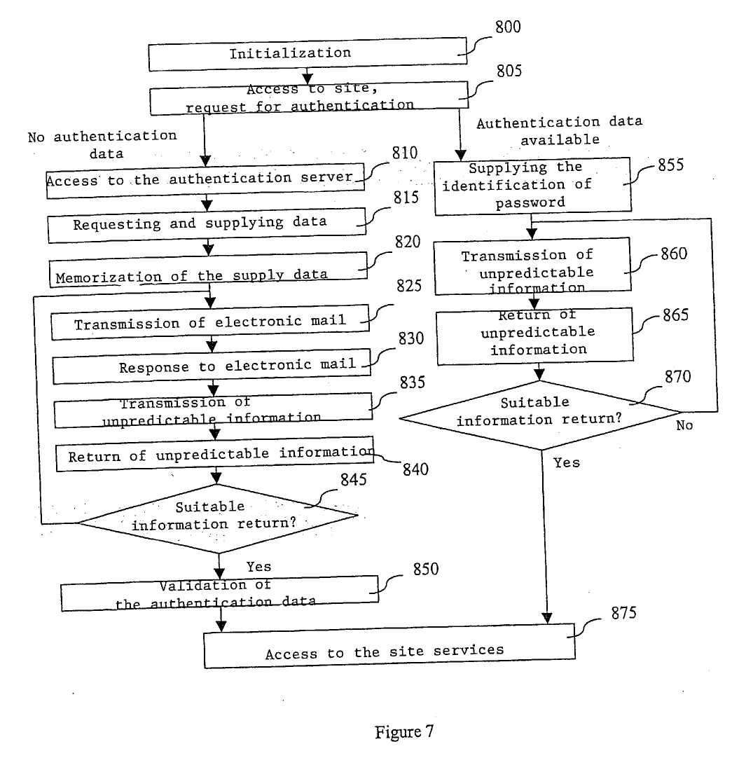

FIG. 6 shows an embodiment of a device according to the fifth aspect of the present invention,

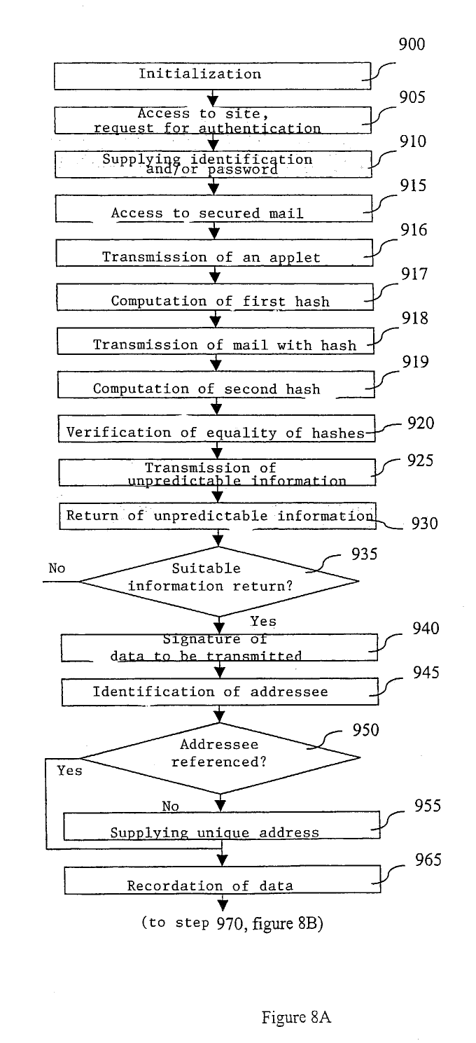

FIG. 7 shows a series of operations of a means of practicing a process according to the fourth aspect of the present invention,

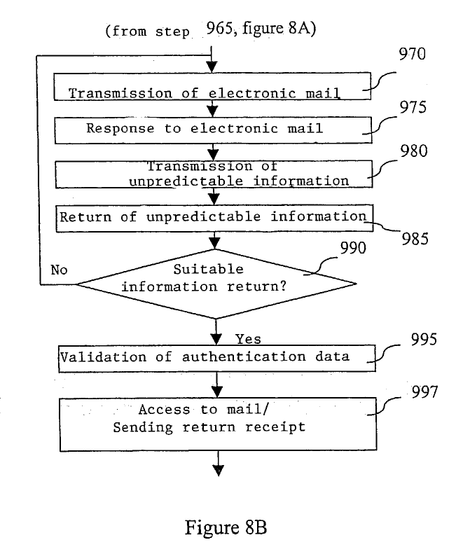

FIGS. 8A and 8B show a sequence of operations of a second embodiment of a process according to the fourth aspect of the present invention,

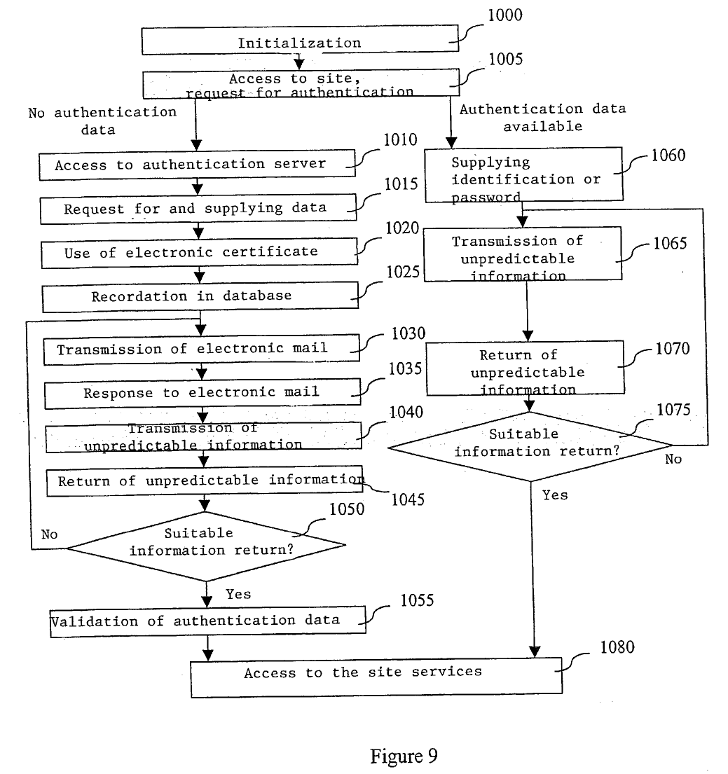

FIG. 9 shows a sequence of operations of a third embodiment of a process according to the fourth aspect of the present invention, and

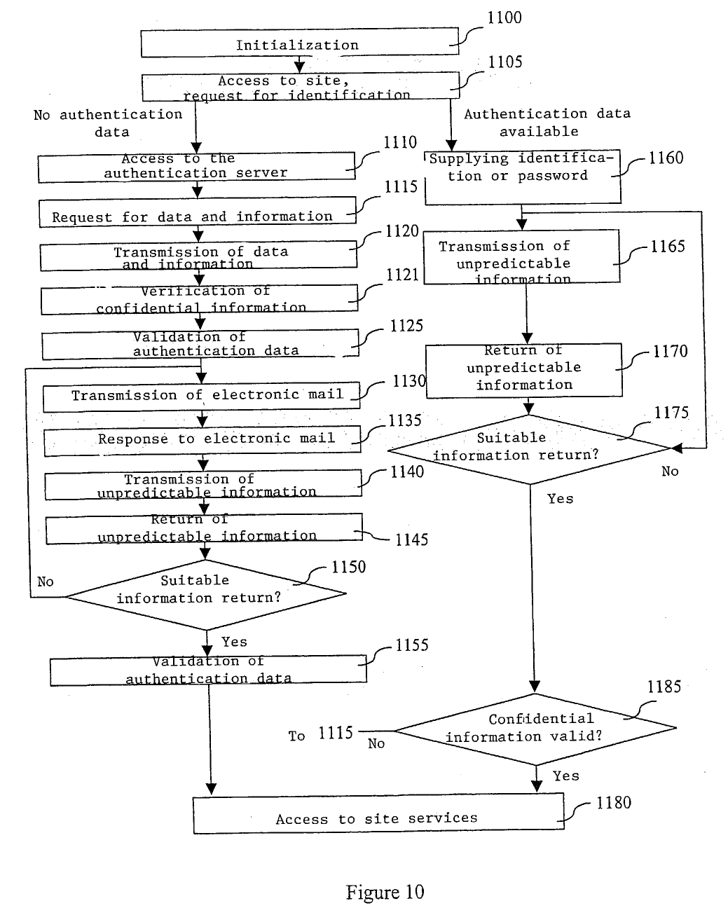

FIG. 10 shows a sequence of operations of a fourth embodiment of a process according to the fourth aspect of the present invention.

In all the description, the term “terminal with a single address” indicates a terminal on a communication network whose address cannot be attributed to another terminal. For example, a telephone or a pager is a terminal with a unique address.

In FIG. 1 are shown a first user terminal 100 connected, by means of a first communication network 110, to a network server 120, itself connected to a second communication network 130 to which is also connected a second communication terminal 140.

The first user terminal 100 is for example a personal computer (PC) or a network computer (NC) or any device permitting connection to the server 120 by means of the first network 110.

The first communication network 110 is for example the Internet. The network server 120 is of known type. It is adapted to receive information from the first terminal 100, to decode at least a portion of this information, to send a communication with the second terminal 140, for example by means of gateway and to transmit the information to send second terminal 140. The second communication network 130 is a communication network with unique addresses, which is to say on the second communication network 130, each terminal, for example the second terminal 140, has an address belonging to it. For example, the second network 130 is a telephone network, for example of mobile telephony.

At the outset, the first user terminal 100 opens a communication session with the network server 120, by means of the first communication network 110, in a known manner, operation 153. This session can be permanent or not. This session can be either directly established between the first user terminal 100 and the network server 120, or by means of a third party server, for example a merchant site server or for social or fiscal announcement, or for electronic messaging and this, either by the use of an electronic connection, or by two simultaneous sessions, one between the first user terminal 100 and the third party site server, and the other between the third party site server and the network server 120.

Then, in the course of an information transmission operation 155, the first user terminal 100 transmits to the network server 120 identification information permitting the network server 120 to determine the unique address of the second terminal 140.

In exemplary embodiments, the identification information comprises a password and a user name which have been previously determined between the user of the first user terminal 100 and the network server 120.

In exemplary embodiments, the identification information comprises, in a coded manner, a unique address of the second terminal 140 on the second communication network 130. For example, the encoding of the unique address is carried out with a private key of the user according to the PKI infrastructure.

In an exemplary embodiment, the identification information comprises the address of the second terminal 140, coded by a public key whose private key is retained by the network server 120.

In exemplary embodiments, the first user terminal 100 transmits to the network server 120 a certificate according to the public key infrastructure PKI.

In exemplary embodiments, the first user terminal 100 transmits to the network server 120 a certificate according to the PKI (Public Key Infrastructure) which comprises a field in which is located, in a coded manner, the unique address of the second user terminal 140.

In exemplary embodiments, the first user terminal 100 transmits to the network server 120 a certificate according to the public key infrastructure PKI, which comprises a field in which is located, in a manner coded with a public key whose private key is retained by the network server 120, the unique address of the second user terminal 140.

In exemplary embodiments, the first user terminal 100 transmits to the network server 120 a certificate according to the public key infrastructure PKI which comprises:

a field in which is located, in a manner coded with a public key whose private key is retained by the network server 120, the unique address of the second user terminal 140,

one or several fields of another certificate according to the PKI, and

in exemplary embodiments, a pointer toward a confidential third party server which authenticates one of the certificates.

The network server 120 determines, from a user database or by decoding the identification information transmitted in the course of operation 155, the unique address of the second terminal 140, operation 157. Then, the network server 120 determines unpredictable information, operation 159. In an exemplary embodiment, the unpredictable information depends on the identity of the user of the first user terminal 100, on an amount of transaction, on a certificate emitted by said user and/or on information to be signed by said user, all or a portion of this information being adapted to be supplied by a third party site, intermediary in the session, cited above. For example, if the user has transmitted the information to be signed, the unpredictable information depends on a hash of said information. The network server 120 transmits, by means of the second communication network 130, to the second user terminal 140, said unpredictable information, operation 161. In exemplary embodiments, said information is transmitted in the form of a short message (known as a short message system SMS).

The user of the first terminal 100 and of the second terminal 140 retransmits to the network server 120 said unpredictable information, by means of the first communication network 110, operation 163. For example, the user reads said unpredictable information on the screen of the second user terminal 140 and acquires this unpredictable information on a keyboard of the first user terminal 100. According to another example, the user connects, for example, by an infrared connection, the terminals 100 and 140 so that the unpredictable information transits, under control of the user, and automatically, from the terminal 140 to the terminal 100.

The network server 120 verifies that the conformity of the information that is receives from the first terminal 100 with the unpredictable information transmitted to the second user terminal 140, operation 165. In case of agreement, the network server 120 authorizes access of the user to an accessible resource by the first communication network 110, operation 167. Such a resource is for example a payment, an authentication, a service reserved for subscription, an information signature. Preferably, all of the operations 153 to 267 are carried out during the open session in the course of operation 153.

In the case in which information (an order voucher, an e-mail, a payment) is signed by using the operations described above, a third party destination of said information can require verification of the signature and/or decoding the information. In this case, the third party destination interrogates the network server 120, operation 169. In exemplary embodiments, the database preserved by said network server 120 comprises a means for obtaining said unique address of the second terminal 140 (for example the unique address or a private key for deciphering the unique address transmitted by the user) and a pointer of a database for certification of a third party certifier which preserves the information necessary to verify the electronic signature. The network server 120 thus redirects the third party destination toward the server of the third party certifier, operation 171.

In exemplary embodiments, the third party destination directly interrogates the database for certification of the third party certifier.

A user who wishes to benefit from the advantages of the present invention first signs in with the third party certifier. To this end, according to the rules in force, the user supplies' proof of his identity to the third party certifier and the latter, in exemplary embodiments, gives him a certificate route which permits the user to use, on his first terminal, a first electronic certificate. The user supplies to the management of the network server 120, a subscription invoice to the network on which the user utilizes the second terminal, said invoice corresponding to the second terminal and a means to verify the first electronic certificate, operation 141. The network server 120 supplies to the first terminal 100 a second electronic certificate which, according to an aspect of the present invention, permits the network server 120 to determine the unique address of the second terminal 140 on the second communication network 130 and a pointer permitting connecting the second electronic certificate to the database of the third party certifier, operation 145. For example, the second certificate comprises, in a manner expressed by a public key of the network server 120, the address of the second terminal 140 on the second network, the network server 120 carrying out operation 143 of corresponding calculation. In exemplary embodiments, the second certificate comprises an identification of the third party certifier, for example in the form of a pointer.

In embodiments, the network server 120 retains in a database, the address of the second terminal 140 and a pointer corresponding to the database of the third party certifier.

In exemplary embodiments, the second certificate comprises said unique address of the second terminal 140 on the second communication support 130 and points to, which is to say identifies or comprises, another certificate, for example according to the PKI which does not include a unique address.

In FIG. 2 are shown a first user terminal 200 connected, by means of a first communication network 210, to a network server 220, itself connected to a second communication network 230 to which is also connected a second communication terminal 240.

The first user terminal 200 is for example a personal computer (or PC) or a network computer (or NC) or any device permitting connecting to the server 220 by means of the first network 210.

The first communication network 210 is for example the Internet. The network server 220 is of known type. It is adapted to receive information from the first terminal 200, to send a communication with the second terminal 240, for example by means of a gateway and to transmit information to said second terminal 240. The second communication network 230 is a communication network with unique addresses, which is to say that on the second communication network 230, each terminal, for example the second terminal 240, has an address special to it. For example, the second network 230 is a telephonic network, for example of mobile telephones.

At the outset, the first user terminal 200 opens a communication session with the network server 220, by means of the first communication network 210, in a known manner, operation 253. This session can be permanent or not. This session can be either directly established between the first user terminal 200 and the network server 220, or by means of a third party server, for example a server of a merchant's site or social or fiscal announcement, or an electronic mail and this either by use of an electronic connection, or by two simultaneous sessions, one between the first user terminal 200 and the server of the third party site, and the other between the server of the third party site and the network server 220.

Then, in the course of an operation of information transmission 255, the first user terminal 200 transmits to the network server 220 identification information permitting the network server 220 to determine the unique address of the second terminal 240.

In exemplary embodiments, the identification information comprises a password and a name of a user, which have been previously adopted between the user of the first user terminal 200 and the network server 220.

In exemplary embodiments, the identification information comprises, in a numerical manner, a unique address of the second terminal 240 on the second communication network 230. For example, the number of the unique address is carried out with a private key of the user according to PKI.

In an exemplary embodiment, the identification information comprises the address of the second terminal 240, coded according to a public key whose private key is retained by the network server 220.

In exemplary embodiments, the first user terminal 200 transmits to the network server 220, a certificate according to the PKI.

In exemplary embodiments, the first user terminal 200 transmits to the network server 220, a certificate according to the PKI which comprises a field in which is located in a coded manner, the unique address of the second user terminal 240.

In exemplary embodiments, the first user terminal 200 transmits to the network server 220, a certificate according to the PKI which comprises a field in which is located, in a coded manner with a public key whose private key is retained by the network server 220, the unique address of the second user terminal 240.

In exemplary embodiments, the first user terminal 200 transmits to the network server 200, a certificate according to the PKI which comprises:

a field in which is located, in a coded manner with a public key whose private key is retained by the network server 220, the unique address of the second user terminal 240,

one or several fields of another certificate according to the PKI, and

in exemplary embodiments, a pointer toward a confidential third party server which authenticates one of the certificates.

The network server 220 determines, from a user database or by decoding the identification information transmitted in the course of operation 255, the unique address of the second terminal 240, operation 257. Then, the network server 220 determines unpredictable information, operation 259. In an exemplary embodiment, the unpredictable information depends on the identity of the user of the first user terminal 200, on the amount of a transaction, on a certificate emitted by said user and/or on information to be signed by said user, all or part of this information being adapted to be supplied by a third party site, an intermediary in the session, cited above. For example, if the user has transmitted information to be signed, the unpredictable information depends on a hash of said information. The network server 220 transmits, by means of the second communication network 230, to the second user terminal 240, said unpredictable information, operation 261. In exemplary embodiments, said information is transmitted in the form of a short message (known as SMS for Short Message System).

The user of the first and second user terminals 200 and 240 retransmits to the network server 220 said unpredictable information, by means of the first communication network 210, operation 263. For example, the user reads said unpredictable information on the screen of the second user terminal 240 and acquires this unpredictable information on a keyboard of the first user terminal 200. According to another example, the user connects, for example, by an infrared connection, the terminals 200 and 240 such that the unpredictable information transits, under the control of the user, and automatically, from the terminal 240 to the terminal 200.

According to one aspect of the present invention, the transmission of the unpredictable information by the first terminal 200 gives rise to the use or the transmission of a user certificate preserved in the first user terminal 200 such that the information received by the network server 220 depends on said user certificate, operation 265. In exemplary embodiments, said user certificate is according to the PKI.

The network server 220 verifies the conformity of the information which it receives from the first terminal 200, to the unpredictable information transmitted to the second user terminal 240, operation 267. For example, the unpredictable information has been signed by the user certificate (the private key in the case of a user certificate according to PKI) and the network server 220 decodes (with the public key corresponding to the private key, in the case of a user certificate according to PKI) the unpredictable information. In the case of agreement, the network server 220 authorizes access of the user to an accessible resource by the first communication network 110, operation 269. Such a resource is for example a payment, an authentication, a service reserved for subscriptions, a signature of information, operation 269. Preferably, the assembly of operations 253 to 269 is carried out during the open session in the course of operation 253.

In the case in which information (an order receipt, an e-mail, a payment) is signed by using the operations described above, a third party destination of said information can require verification of the signature and/or decoding of the information. In this case, the third party destination interrogates the network server 220, operation 271. In exemplary embodiments, the database contained in said network server 220 comprises a means for obtaining said unique address of the second terminal 240 (for example the unique address for a private key for decoding the unique address transmitted by the user) and a pointer of a database for certification of a third party certifier which preserves the information necessary to verify the electronic signature. The network server 120 thus redirects the third party destination toward the server of the third party certifier, operation 273.

In exemplary embodiments, the third party destination directly interrogates the database for certification of the third party certifier.

A user who wishes to benefit from the advantages of the present invention first signs in with the third party certifier. To this end, according to regulations in force, the user supplies proofs of his identity to the third party certifier and the latter, in exemplary embodiments, gives him a certificate route which permits the user to use, on his first terminal, a first electronic certificate. The user supplies to the manager of the network server 220, a subscription invoice to the network on which the user desires to use the second terminal, said invoice corresponding to the second terminal and a means to verify the first electronic certificate, operation 241. The network server 220 supplies to the first terminal 200 a second electronic certificate which, according to one aspect of the present invention, permits the network server 220 to determine the unique address of the second terminal 240 on the second communication network and a pointer permitting connecting the second electronic certificate to the database of the third party certifier, operation 245. For example, the second certificate comprises, in a manner coded by a public key of the network server 220, the address of the second terminal 240 on the second network, the network server 220 carrying out the corresponding operation 243 of encoding. In exemplary embodiments, the second certificate comprises an identification of the third party certifier, for example in the form of a pointer.

In embodiments, the network server 220 preserves in a database, the address of the second terminal 240 and a pointer corresponding to the database of the third party certifier.

In exemplary embodiments, the second certificate comprises said unique address of the second terminal 240 on the second communication support 230 and points to, that is identifies or comprises, another certificate, for example according to PKI, which does not comprise said unique address.

In exemplary embodiments, a merchant site uses a certificate according to PKI, then, for example as a function of the amount of interest in play or of payment, the merchant site transmits a request for authentication to the network server 220 by identifying the client thanks to the information of the certificate according to PKI. The network server 220 then determines the unique address of the second user terminal 240 as indicated above and transmits unpredictable information to this second user terminal 240. The user of the first and second user terminals 200 and 240 retransmits to the network server 220 said unpredictable information, by means of the first communication network 210. For example, the user reads said unpredictable information on the screen of the second user terminal 240 and acquires this unpredictable information on a keyboard of the first user terminal 200. According to another example, the user connects, for example, by an infrared connection, the terminals 200 and 240 so that the unpredictable information transmits, under the control of the user, and automatically, from the terminal 240 to the terminal 200.

In the transaction diagram shown in FIG. 3, a client is inscribed and has an account at a financial organization which uses a payment server adapted to determine a terminal address on a communication support in which each address is attributed to at most one terminal. This account permits it to have a file of conservation of confidential data known as “Server Side Wallet”. In this file is stored information relative to the mode of payment available to the client.

The financial organization is of the “issuer” type, which is to say issuer of payment means, here single usages, or it is an intermediate having reached agreement with “issuer” banks.

The merchant has an agreement with the “issuer” financial organization and has an open account which is not necessarily subject to his conventional bank account in his so-called “acquirer” bank because it receives payments for the account of the merchant.

The merchant displays, on the payment page at his site, an icon inviting customers to pay by means of a designated payment means. It will be observed that this icon could be that of a bank or of a type of bank card.

In the particular embodiment shown in FIG. 3, a client accepts, by means of a terminal 300 and a computer network 310, for example Internet, at a merchant site 320, housed in a network server 330. The client identifies himself by giving his names, given names and address or by the transmission, by the terminal 300, of a unique certificate delivered to the client, for example a certificate connected to the PKI. To pay, let it be supposed in what follows of the description of FIG. 3, that the client selects a payment option by means of payment by unique electronic usage proposed by the merchant site 320. It will be observed that the merchant site 320 can propose only this option, because, differently from payments by bank card without signature, the client cannot repudiate a payment made with signature or authentication.

The network server 330 then transfers the client to a payment site 340 housed in a network server 350, or payment server. In exemplary preferred embodiments, the network server 330 of the merchant site 320 transmits to the network server 350 of the payment site 340, information representative of the identity of the merchant, of bank references of the merchant, of the identity of the customer, of a unique certificate delivered to the customer according to PKI, of the amount of the transaction, of the time and date and/or the goods or services concerned in the transaction. In exemplary embodiments, the client supplies all or a part of this information to the server 350 by means of the terminal 300, for example by transmission of a unique certificate delivered to the client according to the PKI or by acquisition on the keyboard.

The payment server 350 determines whether the payment can be authorized, for example as a function of the identity of the client, of the amount of the payment, of the condition of the financial or bank account of the client, according to known procedures. If the payment can be authorized, the server 350 of the payment site 340 transmits the certificate according to PKI to a signature server 360 which carries out an authentication in a manner similar to those carried out by the network servers 120 and 220 described above.

As a modification, the signature server 360 or the payment server 350 transmits to the terminal 300 information, for example an image, representative of an electronic unique usage payment means, for example an image of a check, to the terminal 300 of the client. In exemplary embodiments, this electronic unique usage payment means is already partially or completely pre-filled in, with all or a portion of the information transmitted previously by the client or the merchant site 320. The client validates or not the payment by acquiring the unpredictable information received on a telecommunication terminal 370 (the second user terminal) connected to the client.

It will be observed that the unpredictable information, also called “single use seal”, takes the form of a sequence of symbols which, in exemplary embodiments, depends on at least one element of the transaction, for example, the amount, identity of the merchant, identity of the client, a unique certificate delivered to the client, the time and date and/or object of the transaction. For example, the seal is determined as a mathematical function (for example a hash) of all or a part of these elements. Preferably, the seal depends on the identity of the client and/or on a unique certificate delivered to the client (for example connected to PKI).

In exemplary embodiments, the signature server 360 transmits to the telecommunication terminal 370 at least one element of the transaction, for example the amount, the identity of the merchant, the identity of the client, the time and date and/or object of the transaction in addition to the seal.

In exemplary embodiments, to validate the payment, the client reads the seal on a terminal screen 370 or listens to the symbol sequence dictated by a vocal service on a loudspeaker of the terminal 370, then acquires the seal on the terminal 300, for example by the keyboard or by verbal dictation. In modifications, the client connects the terminal 370 to the terminal 300 so that the transmission of the seal takes place automatically.

In the case of absence of correspondence between the seal emitted by the signature server 360 and the seal received by the server 360, the signature server 360 transmits information of error of signature to the server 350 and the server 350 informs the client of the error of the signature and asks him once more to supply the seal and the operation of verification of the seal is repeated. After three failures, the signature server 360 invalidates the seal and the payment server 350 transmits information of absence of payment to the server 330.

Although, in the description of FIG. 3, the servers 330, 350 and 360 have been shown as separated, in exemplary embodiments, at least two of the servers 330, 350 and 360 can be combined.

Preferably, the operations carried out by the signature server 360 all take place in the course of the same communication session between the terminal 300 and the server 350. Preferably, this communication session is secured, for example encrypted according to the encryption standard SSL.

In exemplary embodiments, the seal is selected from an assembly of numbers similar to the numbers of the pay card embossed such that the merchant site 320 utilizes the seal as a conventional payment card number, knowing that the payment cannot be repudiated by the client.

If desired, the payment server or the signature server determines a maximum duration of validity of the number of the single use payment means and/or of the seal. If desired, the signature server transmits to the terminal 370 the amount of payment and/or an identification of the merchant site.

In exemplary embodiments, the single use payment number takes the form of a payment card number of known type, and the user uses the single use payment number as a number of a payment card embossed on a payment card of plastic material.

In FIG. 4 are shown a user station or computer system emitter 400, an Internet application 410, a white room 420, a storage memory 430, a second communication network 440 and a receiver 450 on the second communication network 440. The white room 420 comprises a firewall 460, a security server 470 and a certificate generator 480. The operations carried out in the particular embodiment shown in FIG. 4 are shown in rectangles numbered from 500 to 512. The Internet application 410 and the white room 420 are conjointly called the receiver computer system.

The user station 400 is for example a personal computer (PC), a network computer (NC) or a personal digital assistant (PDA) or any terminal permitting remote communication, inactive terminal, TV decoder, . . . The user station 400 is provided with remote communication software to use the Internet 410, conjointly with the security server 470. This remote communication software can be navigation software or electronic mail software, for example.

The Internet application 410 permits communication between the user station 400 and the security server 470 and the transmission of data from the user station 400 to the storage memory 430, for example by means of the security server 470. The white room 420 is a space protected against any physical intrusion, such as a bank vault. The storage memory 430 is a memory adapted to preserve data for a long period, more than a year.

The second communication network 440 is for example a telephone network and, also more particularly a mobile telephone network or an alphanumerical receiver, commonly called a “pager”. The second network 440 is called “second” by comparison with the Internet, which is also called the “first” network in what follows of the present application. The second network 440 is adapted to transmit a key, a seal, a hash or a certificate from the safety server 470 to the receiver 450. The receiver 450 in the second network 440 can, according to the type of second network 440, be a mobile telephone, a pager or any receiver. The receiver 450 permits the user at the user station 400 to take account of information transmitted by the security server 670.

The firewall 460 is of the material and/or software type and prevents any software intrusion into the security server 470. The security server 470 is a computer server of known type. Finally, the certificate generator 480 is adapted to generate disposable certificates, for example of the type according to the PKI, for example according to the standard X509-V3.

The user station 400 and the security server 470 are conjointly adapted to use operations indicated below. For example, the security server 470 is adapted to supply applicative routines or “applets” to the user station 400.

At the beginning of the certification process, let it be supposed that data are to be transmitted in a certified manner and signed, from the user station 400 to a third party destination. The data in question can be supplied by the user of the user station 400 or by the third party destination, for example a merchant site server of a social or financial declaration site or an electronic mail server.

The user of the user station 400 connects himself to the security server 420 to start the certification process. This connection, or session, can be either directly established between the user station 400 and the security server 420, or by means of a third party server, for example the third party destination server and this, either by the use of an electronic connection, or by two simultaneous sessions, one between the user station 400 and the server of the third party site, and the other between the third party site server and the security server 420.

In the course of an operation 500, the user of the user station 400 identifies himself by supplying identification information permitting the security server 420 to determine the unique address of the receiver 450.

In exemplary embodiments, the identification information comprises a password and a user name which have been previously determined between the user of the user station 400 and the security server 420.

In exemplary embodiments, the identification information comprises, in a coded manner, a unique address of the receiver 450. For example, the coding of the unique address is carried out with a private key of the user according to PKI.

In an exemplary embodiment, the identification information comprises the address of the receiver 450, coded by a public key whose private key is retained by the security server 420.

In exemplary embodiments, a third party supplying data to the signer for the third party destination, supplies the unique address of the receiver 450 or the certificate according to PKI of the user, or the public key of this certificate.

In exemplary embodiments, the user station 400 transmits to the security server 420, a certificate according to PKI.

In exemplary embodiments, the user station 400 transmits to the security server 420 a certificate according to PKI which comprises a field in which is located, in a coded manner, the unique address of the receiver 450.

In exemplary embodiments, the user station 400 transmits to the security server 420 a certificate according to PKI which comprises a field in which is located, in a coded manner with a public key whose private key is retained by the security server 420, the unique address of the receiver 450.

In exemplary embodiments, the user station 400 transmits to the security server 420, a certificate according to PKI which comprises:

a field in which is located, in a coded manner with a public key whose private key is determined by the security server 420, the unique address of the receiver 450,

one or several fields of another certificate according to the PKI, and

in exemplary embodiments, a pointer toward the third party server of confidence which authenticates one of the certificates.

In exemplary embodiments, the operation 500 takes place after the operation 503 described below and the user station 400 uses the discardable certificate to code the unique address of the receiver 450 and transmits the coded unique address to the security server 420.

In the course of operation 501, after identification of the user at the user station (for example by a user name and password), the Internet application 410 telecharges a certified and signed applicative routine in the user station 400. It will be noted that the applicative routine in question can be telecharged only in the case in which a copy of this routine has not already been implanted in the user station 400. This particular characteristic permits rendering portable the certification process which is the object of the present invention, without slowing this process in the case in which the user uses successively the same user station 400, for several certifications of data. In the course of operation 502, the certificate generator 480 generates a discardable certificate, for example in the form of a private key according to PKI, for example according to the standard X509-V3. For example, the discardable certificate is generated randomly by the generator 480.

In the course of operation 503, the security server 470 transmits the discardable certificate to the user station 400. In the course of operation 504, the user station 400 uses the applicative routine telecharged in the course of operation 501 to obtain a track of data to be transmitted, called hash, which track depends on the discardable certificate generated in the course of operation 502 and the data transmitted and which permits the detection of any ultimate modification of the data to be transmitted.

In the course of operation 505, the data to be transmitted and the hash are telecharged from the user station 400 to the Internet application 410. Moreover, the coordinates of each destination of the data to be transmitted are transmitted by the user station 400 to the Internet application 410. These coordinates can take the form of an electronic mail address or e-mail, of a telephone number, or of any other type of information permitting contacting each destination of the data to be transmitted. In the course of operation 506, the integrity of the data to be transmitted is verified, by using the discardable key generated in the course of operation 502 and the hash.

It will be noted that at the end of operation 506, a copy of the data to be transmitted has been made from the user station 400 in the Internet application 410 and that this copy is certified according to the original, thanks to the use of a discardable key. To avoid the discardable certificate being reused, in the course of operation 510, the discardable certificate is revoked, which is to say that it becomes unusable to certify data.

As a modification, the discardable certificate generated in the course of operation 502 is a certificate of very short lifetime, preferably less than one hour. In this modification, operation 510 is not executed because, beyond the duration of the lifetime of the discardable certificate, the certificate is not usable to certify data.

Operations 507 and 508 correspond to an example of signature and can be used in combination with operations 501 to 506 above. In the course of operation 507, a secret seal is generated and transmitted, by means of the second network 440, to the receiver 450.

In exemplary embodiments, the address of the receiver 450 on the second network is determined by placing in correspondence the identification of the user transmitted in the course of operation 500, with said address, in a correspondence table. In exemplary embodiments, the address of the receiver 450 is decoded by the server 420 (see FIGS. 1 and 2). Preferably, the secret seal is computed on the elements of signature of the document. Preferably, the secret seal depends on the data to be transmitted, their number, their content, and the date and hour of the generation of the secret seal, of the private key of the emitter of data determined in correspondence with the identification of the user transmitted in the course of operation 501, of the Internet address of the user station 400 and/or of a number of an Internet session in the course of which the data are transmitted. In an example of the use of operation 507, the secret seal is obtained by computing a hash of the data to be transmitted, for example in the form of a sequence of 20 symbols, encoding this hash by a private key of the user of the user station 400, and extracting a portion of the result of this encoding, for example eight symbols out of 20.

Preferably, at least one coordinate of at least one destination of the data to be transmitted, is transmitted with the secret seal, in the course of operation 507, such that the emitter user can identify the message which he is about to sign.

The reader could refer to the patent application PCT/FR 98/02348, incorporated herein by reference, for better understanding the examples of steps of the procedure in the course of operations 507 and 508. In the course of operation 508, the common user of the user station 400 and of the receiver 450 acquires the secret seal and the secret seal is transmitted to the security server 470 where the seal is verified, operation 509.

As a modification, operations 507 to 509 are replaced by a signature operation based on the use of a memory card (smart card) or a biometric measurement or any other means considered reliable for the definitive authentication of the user.

At the end of operation 508, the transmitted data are thus certified to be valid and signed by the user who transmits them. Operation 509 consists in substituting a so-called PKI signature for the signature carried out in the course of operations 507 and 508.

This signature can be either the signature of the user, if it is known to the security server 420 or transmitted by the user station 400, or the signature of the security server 420, or the public key of the third party destination.

In the course of operation 509, the transmitted data are signed with the private key of the user who has transmitted them (called data “signatory”).

The user thus has access to a resource of the first communication network, for example, the transmission of the authenticated electronic mail, the access to data or the payment for products or services.

Finally, in the course of operation 511, the transmitted data, certified and signed by the private key, are transmitted to the storage memory 430 with a date and, if desired, a time such that they are time dated, archived and notarized.

In an application of the present invention to retrieval of transmitted data, a destination is, following operation 511, advised of the availability of data to be transmitted and operations similar to the operations explained above are carried out to produce a certified copy according to the user station of the destination after having collected for its part a signature. For example, a signature as set forth in patent application PCT/FR 98/02348 with a suitable certified copy as set forth above, can, again be used to authenticate the destination.

In exemplary embodiments, by the use of a unique address terminal, the client requires of a server, a single use payment card number by supplying a secret code, if desired in the form of a PKI, and by indicating if desired an identification of the merchant, for example placed on the Internet site of the merchant, a maximum payment amount belonging to this single usage payment card number and/or an amount to be paid to the merchant, and receives in return, on the second terminal, a single use credit card number that the client uses to pay the merchant, in a manner known in commerce as on line. To this end, the server determines a single usage payment card number that he places in correspondence with a payment means of the user, and when the merchant requires payment, by transmitting the single usage payment card number, the server carries out the payment with the payment means of the user which corresponds with the single use payment card number. The client is thus ensured that the payment means has not been transmitted on line and the merchant is ensured of being paid because the client is authenticated.

FIG. 5 shows the fields of certificates according to the PKI, according to one aspect of the present invention.

The certificate 600 comprises:

a certificate 601, according to PKI,

a field 602 comprising a unique address of a telecommunication terminal of the user identified by certificates 600 and 601, in a coded manner, for example by the public key of the server which triggers the sending of unpredictable information to the client and which verifies in return the unpredictable information transmitted by the user, and

in exemplary embodiments, a pointer 603 which identifies a database capable of authenticating the certificate 601.

The certificate 601, according to the PKI, is for example generated from data supplied by the certification organism whose database is identified by the pointer 603. It does not represent said unique address. The pointer 603 identifies the database capable of authenticating the certificate 601 by an Internet address, by a domain name or by any other means permitting the server requiring a verification of the identity of the user to obtain this verification by using the database in question.

FIG. 5 also shows the fields of a database used in the exemplary embodiments of the present invention.

In FIG. 6 are shown a first user terminal 710, comprising a visualization screen 711, a modem 712 and a means for acquiring symbols 713, a computer network 720, a server 730, a database 740, a telecommunication network 750 and a second user terminal 760.

The first user terminal 710 is for example a personal computer or a personal assistant, suitable to communicate with the computer network 720, by means of the modem 712. The visualization screen 711 is adapted to display information exchanged on the computer network 720, for example hypertext pages and e-mail, for example by navigation software 714.

The means for acquiring symbols 713 is adapted to permit the user to acquire symbols, for example alphanumeric characters. It comprises for example a tactile screen and/or a keyboard. The computer network 720 is in an open network for example Internet. The server 730 ensures:

communication by means of the computer network 720, with the first terminal user 710,

communication by means of the telecommunication network 750, with the second user terminal 760, and

management of the database 740.

Thanks to software (not shown), the first user terminal 710 and the server 730 are adapted to use operations indicated below and, for example, operations shown in FIGS. 7 to 9.

The database 740 is a database for authentication and traceability. It contains information concerning each authenticated user, comprising at least an electronic address and an address on the telecommunication network 750. The telecommunication network 750 is a network in which each user has a unique address, which is to say that no address is attributed to two users. For example, the telecommunication network 750 is a telephone network, preferably wireless, or a network of mobile alphanumeric receivers, also called “pagers”. The second user terminal 760 is adapted to receive information on the telecommunication network 750. For example, the second user terminal 760 is a telephone, preferably mobile.

To be referenced in the authentication database 740, the user uses the first user terminal 710 to access a computer site, for example a website housed in the server 730. To this end, either he uses an address dedicated to the authentication service, or he is invited, for example by a merchant site or an institutional site, to subscribe to an authentication service housed by the server 730.

The server 730 invites the user to supply information concerning him, including at least one electronic mail address, a unique address of the second user terminal, preferably at least a surname, a given name, a postal address and if desired bank references, a number for subscription to a third party service, an account number, a subscriber number, a declarant number, an assurance number and/or a static password. If desired, the user uses an electronic certificate of authentication of his first user terminal 710, said electronic certificate being according to the PKI. If desired, the user supplies a public key concerning the declared user, which declaring user may be or not the declared user.

Each information acquired by the user, for example by the use of an electronic formula, is memorized in the database 740 and preferably encoded. In the case in which an electronic certificate and/or a public key has been used, identification information of the confidential third party which has emitted said electronic certificate or said public key is memorized in the database.

When sufficient information has been supplied by the user, the server 730 effects the transmission, to the electronic address of the user, of an electronic message or mail, comprising a confirmation of the identity of the user and an invitation to reply to this electronic message, for example by clicking on a connection incorporated in said electronic message.

When the destination user of the electronic mail carries out this response, he is informed, for example by means of a window or a hypertext page, that he will receive unpredictable information on the second user terminal, for example in the form of a short message (short message system) and that he will be able to acquire and transmit it to the server. Preferably, the communication between the first user terminal 710 and the server 730 is thus encoded, for example by using the protocol SSL. The user is also informed that he has only a limited time to acquire and transmit the unpredictable information to the server 730.

The server 730 determines, for example by random sampling, unpredictable information and transmits it to the second user terminal 760. Preferably, the unpredictable information is representative of at least one identification of the user, for example his electronic address and/or the unique address of the second user terminal 760. Upon reception of the unpredictable information, the user acquires with the symbol acquisition means 713, the unpredictable information received on the second user terminal 760 and causes its transmission to the server 730, for example by use of a simple confirmation or validation button.

Upon reception of the unpredictable information, by means of the computer network, the server 730 verifies that the two following conditions are fulfilled:

the unpredictable information received by the server 730 from the first user terminal 710 conforms to the unpredictable information transmitted to the second user terminal 760, and

a predetermination duration (for example five minutes) has not completely elapsed between the transmission and the reception of the unpredictable information.

If these two conditions are fulfilled, the user is considered as authenticated and has access to the authentication services, for example to pay, pass an order or carry out a declaration on an Internet site. This authentication takes the form of memorization of confirmation information in the database 740, with respect to information concerning the user in question.

According to modifications, in the case in which an electronic certificate and/or a public key has been used by the declaring user, this certificate and/or this key is verified by the server, by inviting the declared user to transmit said certificate or to use his private key.

It will be noted that the authentication can be carried out integrally by the user, who thus subscribes to the authentication service for example to emit messages or signed electronic mail or by two users, one the declarant, inscribing the other, the declared, for example on the occasion of sending electronic mail and the declared receiving electronic mail announcing to him that signed electronic mail has been sent to him invalidating the authentication data by receiving and then acquiring unpredictable information, to have access to the signed mail destined for him. In this second case, the validation of the authentication data requires simultaneously the signature of an address of the electronic mail signed by the declared, the server being then able to transmit to the sender of the signed electronic mail, the declarer, a receipt signed in the form of electronic mail.

Thus, the server 730 is adapted to carry out a referencing of the user in an authentication database, and comprises:

a means for reception (for example a modem, not shown, connected to the Internet), on the part of a first user, of an electronic address of a second user that can be identical to the first user, a memorization of said electronic address in the database,

reception means (for example a modem), of the first user, of a “unique” address of said second user on a single address communication network, and memorizing said unique address,

transmission means (for example the modem), to the electronic address of the second user, of a message inviting the second user to respond thereto,

transmission means adapted (for example by ending an SMS message) when the second user responds to said electronic message, to transmit to said unique address unpredictable information,

reception means (for example the modem) on the part of the second user, of said unpredictable information,

verification means (for example its processor provided with suitable software) of the correspondence of said unpredictable information transmitted to the unique address and of said unpredictable information transmitted by said second user and

memorization means (the database 740) of the unique address of the second user, of the electronic address of the second user and of the verification of correspondence between the electronic address and the unique address of the second user.

Thus, the process used conjointly by the server 730 and the first user terminal 710 comprises:

a step of supplying, by a first user, an electronic address of a second user who can be identified to the first user, and for memorization of said electronic address in the database,

a step of supplying a “unique” address of said second user on a unique address communication network, and memorizing said unique address,

a step of transmission, by a server, of the electronic address of the second user, of a message inviting the second user to respond thereto,

when the second user responds to said electronic message, a step of transmission, by said server, to said unique address, of unpredictable information,

a step of transmission, by said second user, to said server, of said unpredictable information,

a step of verification of the correspondence of said unpredictable information transmitted by said server and of said unpredictable information transmitted by said second user and

if the verification of correspondence is positive, a step of memorizing, associated with the unique address of the second user, of the electronic address of the second user of an indication of verification of correspondence between the electronic address and the unique address of the second user.

There will be noted, in FIG. 7, a step of initiating 800, in the course of which the servers and a first user terminal are utilized to use the steps shown in FIG. 7.

Then, in the course of a step 805, the user of the first terminal accesses an Internet site which invites him to provide authentication data or, if the user doesn't have any, to subscribe to an authentication service.

If the user does not have authentication data, in the course of step 810, the first user terminal is placed in direct connection with an authentication server, in a secured communication mode, for example according to the https protocol of SSL. Then, in the course of a step 815, the authentication server asks the user to supply data, comprising at least an electronic address and a unique address of a second user terminal on the telecommunication network in which each user has a different address from that or those of the other users.

Preferably, the user also provides at least one surname, given name, postal address and if desired bank references, a subscription number to a third party service, an account number, a subscriber number, a declarant number, an assurance number and/or a static password for using the authentication service.

Then, in the course of a step 820, the server records in a database, the information provided by the user.

Then, in the course of a step 825, the server transmits to the electronic address supplied by the user electronic mail inviting him to respond, for example, by clicking on a connection inserted in said electronic mail or by accessing at an Internet address dedicated to his authentication (an Internet address is thus created specifically for the user, for example, www.magicaxess.com/jamesstewart9543987 in which james stewart are the given name and surname of the user and 9543987 is a portion of the unpredictable address by the user).

When the user replies to the electronic mail, in the course of a step 830, the first user terminal is in communication, preferably secured, with the authentication server. The authentication server thus informs the user that he will receive unpredictable information on the second user terminal and that the latter should therefore be in condition to receive this information. The authentication server also indicates to the user that he should retransmit, within a predetermined time period, for example during five minutes following reception of the unpredictable information, by means of the first user terminal, the unpredictable information received on the second user terminal.

In the course of a step 835, the authentication server causes to be transmitted to the unique address of the second user terminal, unpredictable information, for example sampled randomly or from a hash of information which has been transmitted and/or of a time of transmission of the unpredictable information.

In the course of a step 840, the user transmits the unpredictable information to the authentication server, by means of the first user terminal.

In the course of a step 845, the authentication server verifies that the information transmitted by the first user terminal corresponds to the information transmitted to the second user terminal and that the predetermined duration has not elapsed before reception of the unpredictable information from the first user terminal.

If the information corresponds, in the course of a step 850, the authentication server validates the authentication data, by memorizing, in the database, in a manner associated with the unique address of the second user, at the electronic address of the second user, an indication of verification of correspondence between the electronic address and the unique address of the second user.

If a password and/or an identification of the user has been determined, said identification or password is thus memorized in association with the electronic address and the unique address of the second user.

Preferably, the verification of correspondence is time dated and the date and hour of the verification is also memorized in association with the unique address and the electronic address of the second user.

In the case of positive verification, the authentication server gives to the user access to services, such as for example the sending of signed electronic mail or access to information available on the Internet which requires authentication of their user, for example bank sites, financial sites, medical sites, social services sites, payment sites as a function of the duration of the connection, adult sites, . . . Preferably, in the course of at least one of steps 815 or 830 to 850, a static password and/or an identification of the user are determined and the user is invited to save them.

If the information does not correspond, step 825 is repeated, knowing that more than three repeated failures of validation of authentication data are not permitted, the authentication data being destroyed after said three failures.

If at the end of step 805, the user indicates that he has authentication data, in the course of a step 855, the user supplies an identification and/or a static password.

If the identification and/or the static password is valid, the server transmits to the second user terminal corresponding to it, unpredictable information, different from all the unpredictable information previously used with said user, and the user is invited to receive unpredictable information and to retransmit it, by means of the first user terminal, to the authentication server, if desired by means of the site on which the user is located, step 860.

In the course of a step 865, the user receives and retransmits, by means of the first user terminal, said unpredictable information.

In the course of a step 870, the authentication server verifies the correspondence between the unpredictable information which is transmitted to the second user terminal and that which he has received from the first user terminal.

In case of correspondence, in the course of a step 875, the services of the site on which the user is located are rendered accessible to him. Failing this, these services are not accessible and steps 855 to 870 are repeated, it will be observed that steps 805 to 820 shown above can be attended by a seller.

Preferably, the verification of correspondence is time dated and the date and time of the verification is also memorized in association with the unique address and the electronic address of the second user.

There will be seen in FIG. 8 an initialization step 900, in the course of which servers and a first user terminal of a so-called “emitter” or “declaring” user are initiated to practice the steps shown in FIG. 8.

Then, in the course of a step 905, the “emitting” user has access, by means of the first terminal, to a transmission site of signed mail with verification of reception carried by the authentication server. Let it be supposed that the “emitting” user is already authenticated in the database of the authentication server, either by having followed the authentication procedure shown in FIG. 7, or by having received a registered mail with return receipt as shown, below, in FIG. 8.

In the course of a step 910, the user supplies an identification and/or static password. If the identification and/or the static password is valid, the user has access to a redaction service of electronic mail well known to those skilled in the art, in the course of a step 915. The user thus redacts his mail and can add to it attached pieces, for example files saved in the first user terminal. To this end, the server uses for example at least one of the processes described in the documents FR 00 13101 or FR 00 15215, which are incorporated herein by reference. In particular, an applet is transmitted to the first user terminal, step 916, if the latter has not already received it. Then a single use electronic certificate, for example according to the PKI, and a hash algorithm are used to provide hash of the attached pieces to be transmitted and/or of the electronic mail, step 917. This hash is transmitted to the authentication server with the mail and the possible attached pieces, step 918, which compute, with the same hashing algorithm and the same single use electronic certificate, step 919, to verify that the data which it has received are exactly identical to the data transmitted by the first user terminal, step 920.

The authentication server transmits to the second user terminal corresponding to the “emitter” user, in the database, unpredictable information, different from all the unpredictable information previously used with said user, step 925, the user being invited to receive the unpredictable information and to retransmit it, by means of the first user terminal, to the authentication server.

In the course of a step 930, the user receives on the second user terminal and retransmits, by means of the first terminal user, said unpredictable information.

In the course of a step 935, the authentication server verifies the correspondence between the unpredictable information which it has transmitted to the second user terminal and that which it has received from the first user terminal. In case the unpredictable information does not correspond, the process is stopped and the user must renew his authentication attempt.

In the case of correspondence, in the course of a step 940, the authentication server signs the data to be transmitted, for example with the private key of the “emitter” user or with the signed mail transmission service with a return receipt.

In the course of a step 945, the “emitter” user is invited to supply and provide the electronic address of the “destination” user or any other identification permitting determining this electronic address (surname, given name, company, for example).

In the course of a step 950, the server determines whether the destination user is referenced in the database. If so, the emitting user can immediately validate the sending of the electronic mail. If not, in the course of a step 955, the “emitting” user is invited to provide and supply a unique address of a fourth user terminal, on a telecommunication network in which each terminal has a different address from all the other terminals, for example a telephone network, for example wireless. Preferably, the emitting user also supplies a surname, a given name and a postal address of the destination user.

Then, in the course of a step 965, the server records in a database the information supplied by the emitting user.

Then, in the course of a step 970 (FIG. 8B), the server transmits to the electronic address supplied by the emitting user electronic mail indicating to the destination user that a signed electronic mail is directed to him and inviting him to respond, for example, by clicking on a connection inserted in said electronic mail or by accessing an Internet address dedicated to his authentication.

When the destination user replies to the electronic mail, in the course of a step 975, the third user terminal, for example of the personal computer type or personal assistant, is in communication, preferably secured, with the authentication server. The authentication server then informs the destination user that he will receive unpredictable information on the fourth user terminal and that the latter should therefore be in a condition to receive this information. The authentication server also indicates to the destination user that he should retransmit, within a predetermined time period, for example for during five minutes following reception of the unpredictable information, by means of the third user terminal, the unpredictable information received on the fourth user terminal.

In the course of a step 980, the authentication server transmits to the unique address of the fourth user terminal, unpredictable information, for example taken at random or from a hash of information which concerns him in the database and/or of the electronic mail addressed to him and/or of a time of transmission of the unpredictable information.

In the course of a step 985, the destination user transmits the unpredictable information to the authentication server, by means of the third user terminal.

In the course of a step 990, the authentication server verifies that the information transmitted by the third user terminal corresponds to the information transmitted to the fourth user terminal and that the predetermined duration has not elapsed before reception of the unpredictable information from the third user terminal.

If the information corresponds, in the course of a step 995, the authentication server validates the authentication data, by memorizing, in the database, in a manner associated with the unique address of the second user, the electronic address of the second user, an indication of verification of correspondence between the electronic address and the unique address of the second user.

If a password and/or an identification of the user have been determined, said identification or said password is also memorized in association with the electronic address and the unique address of the second user.

Preferably, the verification of correspondence is time dated and the date and time of the verification is also memorized in association with the unique address and the electronic address of the second user.

The server then gives to the destination user access to the reception of the signed electronic mail emitted by the emitting user. The reception of the data by the second user (destination) takes place preferably as the transmission of these data by the first user (emitter), with determination of a hash, transmission of an applet and verification of the hash, as indicated in steps 916 to 920 above. Thus, the integrity of the transmitted data is guaranteed.

Upon this access, the identification server returns a message acknowledging receipt to the emitting destination, with or without authentication of the emitting user, step 997. Preferably, in the course of at least one of the steps 970 to 997, a static password and/or an identification of the destination user is determined and the destination user is invited to keep it.

If the information does not correspond, step 970 is repeated, given that no more than three repeated failures of validation of authentication data will be permitted, the authentication data being destroyed after said three failures.

There will be noted in FIG. 9 an initialization step 1000, in the course of which servers and a first user terminal are started to use the steps shown in FIG. 9.

Then, in the course of a step 1005, the user of the first terminal has access to an Internet site which invites him to provide authentication data or, if the user does not have any, to subscribe to an authentication service.

If the user does not have authentication data, in the course of a step 1010, the first user terminal is put directly into connection with an authentication server, in a secured communication mode, for example according to the htpps protocol or SSL. Then, in the course of a step 1015, the authentication server requests the user to provide data, comprising at least an electronic address and a unique address of a second user terminal on a telecommunication network in which each user has a different address from that of all the other users.

Preferably, the user also provides at least one surname, a given name, a postal address and a bank card number, to buy stamps, each stamp being then “dispensed” upon each identification of the user, and/or a static password for use of the authentication service.

Let it be supposed here that the user has an electronic certificate, for example delivered by the American company Verisign (trademark), this certificate authenticating the first user terminal. In the course of a step 1020, the user uses this electronic certificate to certify the data which he provides by means of the first user terminal.

Then, in the course of a step 1025, the server records in a database, the information provided by the user. It will be noted that, according to this embodiment, the database preserves a combination of information permitting a definitive authentication of the user and the secured payment:

the unique address of the second terminal,

the address of the electronic mail,

an indication of confidential third parties who can certify the electronic certificate and an indication of the use of this electronic certificate, and

a bank card number.

Steps 1030 to 1080 correspond respectively to steps 825 to 875. As a modification, during step 1045, corresponding to step 840, the first user terminal uses the electronic certificate to certify the transmission of unpredictable information. Thus, the judicial connection between the authentication data, the certification data and the payment preserved in the database, is reinforced.

It will be noted that the data thus preserved in the database permit attributing an electronic signature of the user, for example in conformity with the PKI, the private key of the user not leaving the authentication server and giving to the user the freedom to change the first user terminal, which certificates of known type do not easily permit. This key can “comprise” a private key of the user to use the electronic certificate, which is to say represented in an unequivocal manner, and permit authentication of the emitting user by inserting, in the key kept by the authentication server, a pointer pointing toward the server of the confidential third party who has emitted the electronic certificate and who thus knows the personal data of the user and can verify them.

According to modifications, the private key generated by the authentication server represents the unique address of the second user terminal, this address being coded, for example by the public code of the identification server. Thus, each time this private key is used, a server receiving a signed document with this private key can question the authentication server and the latter can transmit, receive and verify unpredictable information passing through the second user terminal, then through the first user terminal and, if desired, through the server requiring authentication, as shown in FIGS. 6 to 9.

According to modifications, the user can emplace a computer connection between the first and second user terminal such that the reception and retransmission of unpredictable information will be automatic.

According to modifications, only the hash of the data is transmitted by the first user to the server, a certificate of integrity being added or combined, by the server, to the hash and the user transmitting the data, if desired signed and/or encrypted (by the certificate of integrity and/or by the hash) by a means not shown, for example by attaching to electronic mail, the certificate of integrity permitting the addressee to access the data and/or to verify the integrity of the data.

There will be noted in FIG. 10 a step of initialization 1100, in the course of which servers and a first user terminal are initiated to use the steps shown in FIG. 10.

Then, in the course of a step 1105, the user of the first terminal has access to an Internet site which invites him to provide authentication data or, if the user does not have any, to subscribe to an authentication service. For example, the Internet site is a merchant site, a bank site, an administrative site (social security, retirement office, . . . ), a payment information site (letters of information on line), a personal services site (insurance) or a site for transmission of registered e-mail.

Let it be supposed first of all that the user does not have authentication data. In the course of a step 1110, the first user terminal is connected directly with an authentication server, in secured communication mode, for example according to the https or SSL protocol. Then, in the course of a step 1115, the authentication server requires the user to provide authentication data, comprising at least one electronic address and confidential information.

Preferably, the user supplies, by way of identification data, also at least one surname, a given name, a postal address and/or a static password selected by the user or by the authentication server.

In the course of a step 1120, the user provides confidential information, which is to say that are not accessible to the public at large but available in a database of a third party. This confidential information comprises for example a bank card number, a bank statement, a membership number, an affiliated number, . . . .

In the course of a step 1121, the identification information and the confidential information are supplied to a remote third party server for verification (for example a bank server verifies the bank statement or the bank card number, an insurance server verifies the membership number, a social service server verifies the subscriber number, a subscription service server verifies a subscription number . . . ).

If the correspondence of the information is confirmed, step 1125 is carried out. If not, an error signal is transmitted to the user, for example by e-mail and/or on a page of the authentication site which the user can see, in the course of a step 1122.

Then, in the course of a step 1125, the authentication server and/or the third party server records in a database information supplied by the user.

Steps 1130 to 1180 correspond respectively to steps 825 to 875.

It will be noted that, either in the course of step 1115, or in the course of step 1135, the user is invited to provide a unique address of a second user terminal on a telecommunication network in which each user has a different address from that of all the other users.

It will be noted that, according to this embodiment, the database contains a combination of information permitting positive identification of the user and the secured payment:

the unique address of the second terminal,

the address of the electronic mail,

an indication of confidential third parties who can confirm the confidential information, and

at least one piece of confidential information (bank card number, bank statement, number of the subscriber or member . . . ).

It will be noted that the data thus kept in the database permit attributing an electronic signature of the user, for example in conformity with the PKI, the private key of the user not leaving the authentication server and giving to the user freedom of changing the first user terminal, which certificates of known type do not easily permit. This key can “comprise” a private key of the user for use of the electronic certificate, which is to say to represent it in an unequivocal manner, and permits authentication of the emitting user by inserting, in the key held by the authentication server, a pointer pointing toward the server of the confidential third party who has emitted the electronic certificate and who thus knows the personal and confidential data of the user and can certify them.

According to modifications, the private key generated by the authentication server represents the unique address of the second user terminal, this address being coded, for example by the public key of the authentication server. Thus, each time this private key is used, a server receiving a signed document with said private key can interrogate the interrogation server and the latter can transmit, receive and verify unpredictable information passing through the second user terminal and then the first user terminal and, if desired, through the server requiring identification, as shown in FIGS. 6 to 10.

According to modifications, the user can emplace a computer connection between the first and second user terminals such that the reception and retransmission of unpredictable information will be automatic.

As a modification, the user has an electronic certificate, for example delivered by the American company Verisign, this certificate authenticating the first user terminal. In the course of a step 1122 (not shown), the user uses this electronic certificate to certify the data which he is supplied by means of the first user terminal.

As a modification, during step 1145, corresponding to step 840, the first user terminal uses the electronic certificate to certify the transmission of unpredictable information. Thus, the legal connection between the authentication data, the certification data and the payment data kept in the database, is reinforced.

According to modifications, only the hash of the data is transmitted by the first user to the server, a certificate of integrity being added or combined, by the server, to the hash and the user transmitting the data, if desired signed and/or encrypted (by the certificate of integrity and/or by the hash) by a means not shown, for example by attaching an electronic mail, the certificate of integrity permitting the addressee to access the data and/or to verify the integrity of the data.

When, in the course of another session, the user has access to a site affiliated with the authentication service that the process of the invention permits using, for example on a merchant site, steps 1160 to 1175 are carried out. When the result of step 1175 is positive, in the course of a step 1185, the validity of the confidential information is again verified, as in the course of step 1121. If the confidential information is not valid, steps 1115 to 1135 and 1155 are repeated. If the confidential information is again valid, steps 1180 is carried out.

As a modification, the unpredictable information is a single usage payment means, for example a virtual credit card number.

1. Process for certification which comprises:
an operation of identification of a user in the course of which said user transmits to a server, by means of a first terminal on a first communication network, a certificate representing, in a coded manner, a unique address of a second terminal of said user on a second communication network,
an operation of decoding said unique address by said server, and
an operation of communication between said server and the second terminal.

2. Process according to claim 1 which comprises moreover:
an operation of transmission of unpredictable information, by said server, to said second terminal,
an operation of transmission to said server by means of the first terminal of said unpredictable information,
an operation of verification of said unpredictable information by said server and
if the verification is positive, an operation of authorization of access of the first terminal to a resource of the first communication network.

3. Process according to claim 2, in which, in the course of the identification operation, said user transmits a certificate representing, encoded with a public key, the unique address of the second terminal.

4. Process according to claim 3 in which, in the course of the identification operation, the certificate comprises a means of obtaining a unique address of the second user terminal and a pointer identifying another database comprising the electronic signature information.

5. Process according to claim 4 in which, in the course of the identification operation, the certificate comprises a certificate according to the Public Key Infrastructure.

6. Process according to claim 2 in which, in the course of the identification operation, the certificate comprises a means of obtaining a unique address of the second user terminal and a pointer identifying another database comprising the electronic signature information.

7. Process according to claim 6 in which, in the course of the identification operation, the certificate comprises a certificate according to the Public Key Infrastructure.

8. Process according to claim 1, in which, in the course of the identification operation, said user transmits a certificate representing, coded with a public key, the unique address of the second terminal.

9. Process according to claim 5 in which, in the course of the identification operation, the certificate comprises a means for obtaining a unique address of the second user terminal and a pointer identifying another database comprising electronic signature information.

10. Process according to claim 1 in which, in the course of the identification operation, the certificate comprises a certificate according to the Public Key Infrastructure.

11. Certification device which comprises:
an identification means of a user adapted to transmit to a server, by means of a first terminal on a first communication network, a certificate representing, in a coded manner, a unique address of a second terminal of said user on a second communication network,
a means for decoding said unique address by said server, and
communication means between said server and the second terminal.

12. Device according to claim 11 which comprises moreover:
a transmission means of unpredictable information, by said server, to said second terminal,
transmission means to said server by means of the first terminal of said unpredictable information,
a verification means for said unpredictable information by said server, adapted, if the verification is positive, to permit access by the first terminal to a resource of the first communication network.

13. Device according to claim 12 in which the identification means is adapted to transmit to the server, by means of a first communication network, a certificate representing, coded with a public key, the unique address of the second terminal.

14. Device according to claim 13 in which the identification means is adapted to transmit a certificate comprising a means for obtaining a unique address of a terminal on a communication network and a pointer identifying another database comprising electronic signature information.

15. Device according to claim 14 in which the identification means is adapted to transmit a certificate comprising a certificate according to the Public Key Infrastructure.

16. Device according to claim 12 in which the identification means is adapted to transmit to the server, by means of a first communication network, a certificate representing, coded with a public key, the unique address of the second terminal.

17. Device according to claim 16 in which the identification means is adapted to transmit a certificate comprising a Public Key Infrastructure certificate.

18. Device according to claim 11 in which the identification means is adapted to transmit a certificate comprising a means for obtaining a unique address of a terminal on a communication network and a pointer identifying another database comprising electronic signature information.

19. Device according to claim 11 in which the identification means is adapted to transmit a certificate comprising a means for obtaining a unique address of a terminal on a communication network and a pointer identifying another database comprising electronic signature information.

20. Device according to claim 11 in which the identification means is adapted to transmit a certificate comprising a Public Key Infrastructure certificate.
